(19) United States
(12) Patent Application Publication
(10) Pub. No.: US 2009/0238630 A1
(43) Pub. Date: Sep. 24, 2009

(54) Label roll positioning device of barcode printer

(76) Inventors: Shang-Shih Kuo, Yonghe City (TW); Chin-Chuan Liu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,584

(22) Filed: Mar. 19, 2009

(30) Foreign Application Priority Data
Mar. 24, 2008 (TW) 097205010

(51) Int. Cl. B41J 15/00

(52) U.S. Cl. 400/619

(57) ABSTRACT

A label roll positioning device is provided for a barcode printer and includes at least one slide rail, at least one positioning rail, and at least one pair of roll retainers. The slide rail and the positioning rail are arranged in a parallel manner inside a housing of the barcode printer. The positioning rail forms teeth on a surface thereof. At least one of the roll retainers has a bottom forming a mounting portion that is slidably fit and mounted to the slide rail for being slidable along the slide rail. The roll retainers are spaced to receive a roll of label therebetween in a securely held manner. The roll retainer is provided therein at least one positioning plug having an end forming a locking section. The positioning plug can be downward driven to have the locking section downward projecting out of the roll retainer, and the positioning plug can be upward driven to have the locking section back into concealment inside the roll retainer. Thus, with the roll of label received between the roll retainers, the positioning plug is downward driven and the locking section engages the teeth of the positioning rail to effect positioning and fixing for securely holding the roll of label between the roll retainers. A positioning device with movable and adjustable locking engagement can be realized.

### BACKGROUND OF THE INVENTION

1. Field of the Invention

The present invention relates to a label roll positioning device of a barcode printer, and in particular to a label roll positioning device that is applicable to a barcode printer and features movable and releasable control of locking engagement to properly position roll retainers and a label roll.

2. The Related Arts

A conventional barcode printer includes a label roll to be printed retained inside the barcode printer for feeding a printable label to a printing mechanism for carrying out printing operations. The retention mechanism for the label roll of the barcode printer only functions to retain label roll of fixed diameter and length and is not capable to retain label rolls of different diameters and lengths. This is certainly adverse to the development of the barcode printer industry. Further, it is likely that the label roll cannot be securely retained in the barcode printer, which affects the printing quality of the barcode printer.

### SUMMARY OF THE INVENTION

Apparently, the conventional label roll retaining mechanism of the barcode printer only works for label rolls of limited sizes or a single fixed size, which limits the industrial use of the barcode printer. Also, the conventional label roll retaining mechanism is not capable to securely retain and fix a roll of label inside a barcode printer, leading to problems of loosening of the label roll.

Thus, the present invention is aimed to provide a label roll positioning device for a barcode printer, wherein the label roll positioning device comprises at least one slide rail, at least one positioning rail, and at least one pair of roll retainers. The slide rail and the positioning rail are arranged in a parallel manner inside a housing of the barcode printer. The positioning rail forms teeth on a surface thereof. At least one of the roll retainers has a bottom forming a mounting portion that is slidably fit and mounted to the slide rail for being slidable along the slide rail. The roll retainers are spaced to receive a roll of label therebetween in a securely held manner. The roll retainer is provided therein at least one positioning plug having an end forming a locking section. The positioning plug can be downward driven to have the locking section downward projecting out of the roll retainer, and the positioning plug is selectively upward driven to have the locking section back into concealment inside the roll retainer. Thus, with the roll of label received between the roll retainers, the positioning plug is downward driven and the locking section engages the teeth of the positioning rail to effect positioning and fixing for securely holding the roll of label between the roll retainers. And, thus, a positioning device with movable and adjustable locking engagement can be realized.

The effectiveness of the label roll positioning device of the present invention is that a barcode printer equipped with such a label roll positioning device can accommodate label rolls of various diameters and lengths and further, the label roll can be securely retained in the barcode printer to ensure high quality of label printing.

### BRIEF DESCRIPTION OF THE DRAWINGS

The present invention will be apparent to those skilled in the art by reading the following description of a preferred embodiment thereof, with reference to the attached drawings, wherein:

FIG. 1 is a perspective view showing a barcode printer in which a label roll positioning device constructed in accordance with the present invention is mounted;

FIG. 2 is a front view of the barcode printer, illustrating a structural relationship among roll retainers, a slide rail, and a positioning rail of the label roll positioning device of the present invention;

FIG. 3 is a perspective view of the label roll positioning device of the present invention;

FIG. 4 is an exploded view of the label roll positioning device of the present invention;

FIG. 5 is a perspective view illustrating a practical application of the label roll positioning device of the present invention in securely holding a roll of label in a barcode printer; and

FIG. 6 is a front view of the barcode printer, illustrating engagement between a positioning plug of the roll retainer and teeth formed on the positioning rail.

### DETAILED DESCRIPTION OF THE PREFERRED EMBODIMENT

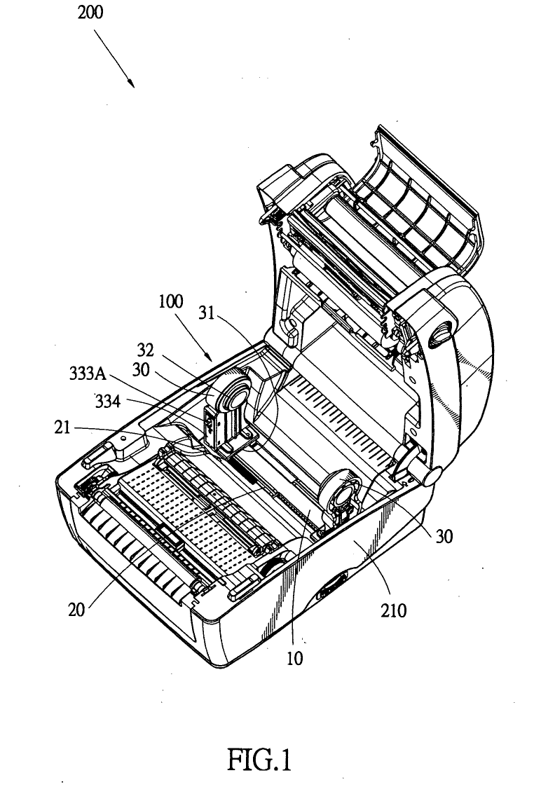

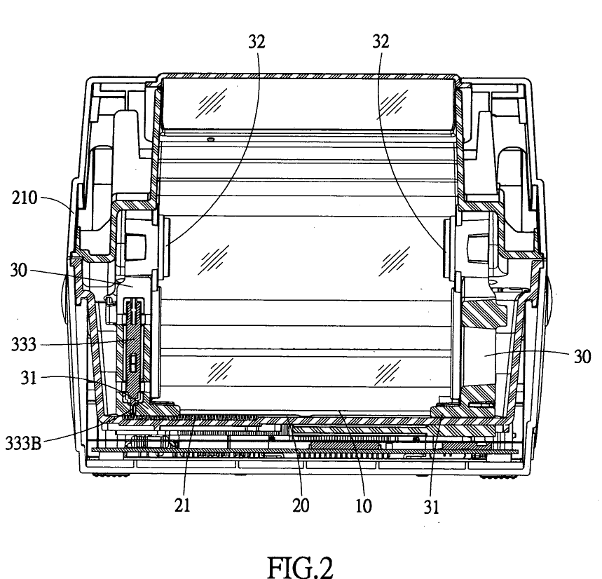

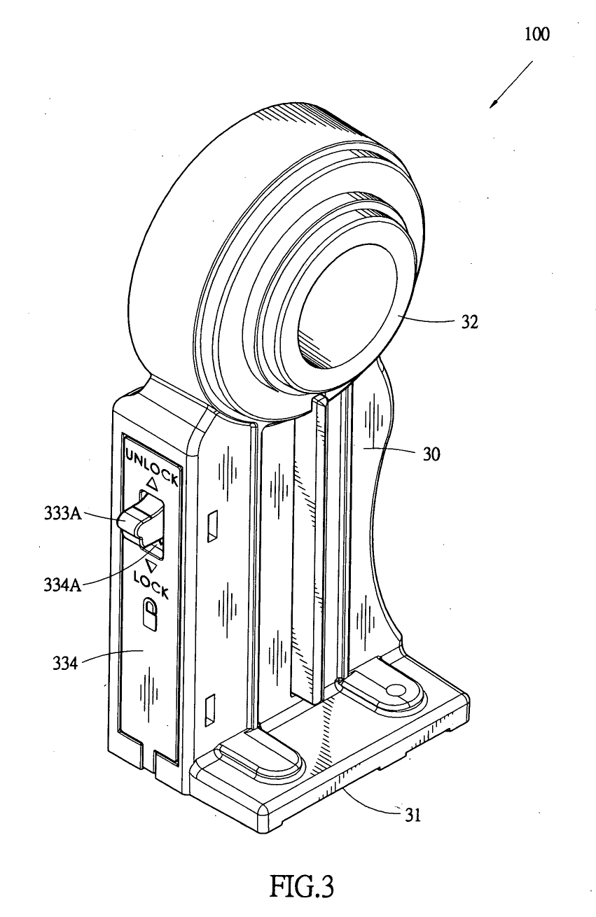

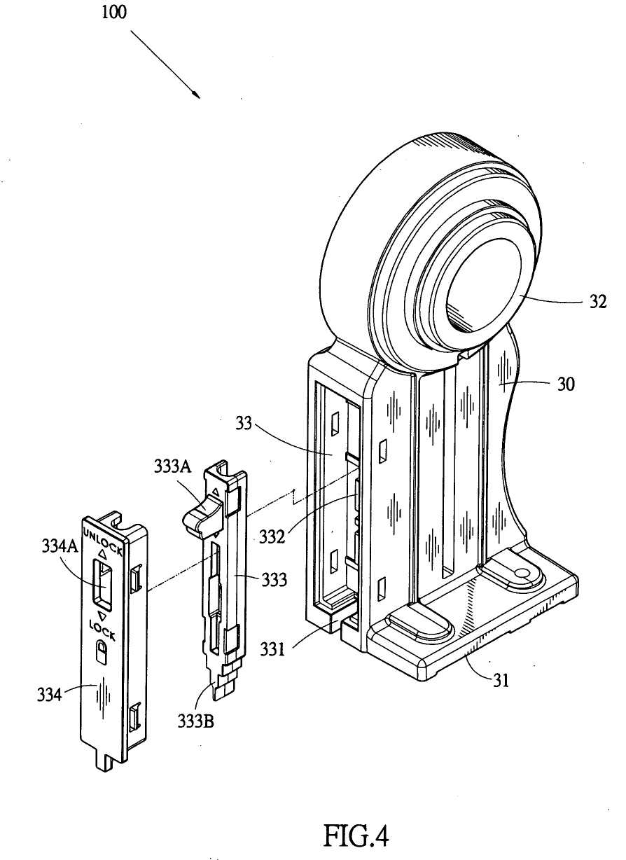

With reference to the drawings and in particular to FIGS. 1-4, a label roll positioning device constructed in accordance with the present invention, generally designated at 100, is provided for a barcode printer, which is designated with reference numeral 200. The label roll positioning device 100 comprises at least one slide rail 10 and at least one positioning rail 20. The slide rail 10 and the positioning rail 20 are arranged inside a housing 210 of the barcode printer 200 in a parallel manner. The positioning rail 20 has a surface forming a series of teeth 21.

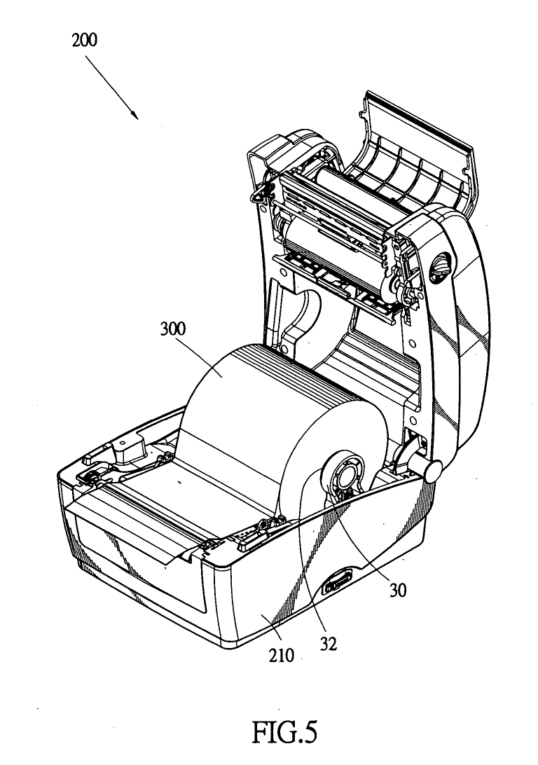

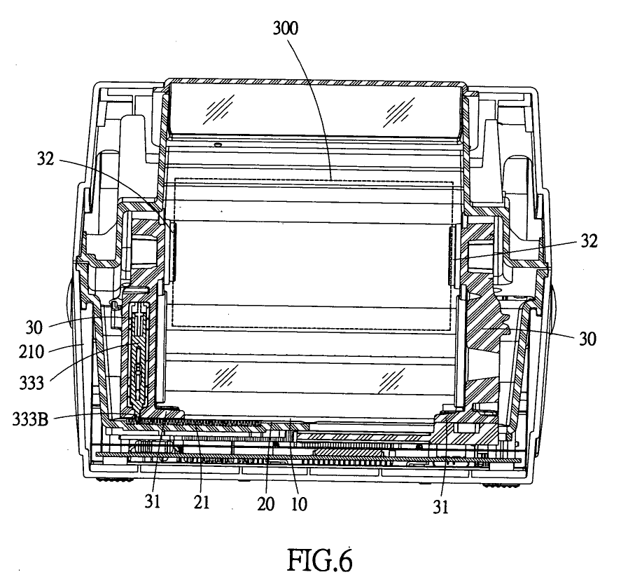

The label roll positioning device 100 further comprises at least one pair of roll retainers 30, preferably (but not necessarily) with each roll retainer associated with one sidle rail and one positioning rail. At least one of the roller retainers 30 has a bottom that forms a mounting portion 31 slidably fit and mounted to the slide rail 10 for being slidable along the slide rail 10. The roll retainers 30 have a top portion having an inside surface opposing each other and forming at least one rotation axle 32, whereby a label roll 300 (see FIGS. 5 and 6) can be received in a space between the roll retainers 30 with ends of the label roll 300 fit over the rotation axles 32 respectively.

One side surface of the roll retainer 30 forms at least one accommodation chamber 33 that is partly delimited by a lower wall in which a projection notch 331 is formed. The projection notch 331 corresponds in position to the teeth 21 of the positioning rail 20. A guide rail 332 is formed inside the accommodation chamber 33. A positioning plug 333 is received in the accommodation chamber 33 and is movably fit over the guide rail 332. An operation handle 333A is formed on one surface of the positioning plug 333 and a locking section 333B is formed on a lower end of the positioning plug 333. The positioning plug 333 can be operated by depressing down the operation handle 333A to have the locking section 333B projecting out of the projection notch 331, or the operation handle 333A of the positioning plug 333 can be pulled upward to withdraw the locking section 333B back into concealment within the accommodation chamber 33 of the roll retainer 30. The accommodation chamber 33 is also provided with a face panel 334, which selectively closes and seals the accommodation chamber 33. The face panel 334 forms an operation opening 334A through which the operation handle 333A of the positioning plug 333 projects out of the accommodation chamber 33.

Also referring to FIGS. 5 and 6, a practical application of the label roll positioning device 100 of the present invention is illustrated. The two roll retainers 30 are allowed to slide along the slide rail 10 to have the label roll 300 fit to and securely held by the rotation axles 32 of the roll retainers 30. The operation handles 333A of the positioning plugs 333 of the two roll retainers 30 are then depressed down to have the locking sections 333B projecting outward to engage the teeth 21 of the positioning rail 20 whereby the label roll 300 is securely held between the two roll retainers 30.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A label roll positioning device for a barcode printer comprising:
at least one slide rail and one positioning rail, which are arranged in a parallel manner inside a housing of the barcode printer, the positioning rail forming teeth on a surface thereof; and
at least one pair of roll retainers, at least one of the roll retainers having a bottom slidably fit to the slide rail for being slidable along the slide rail, the roll retainers having top portions opposing each other and adapted to receive a label roll therebetween, the roll retainer forming at least one accommodation chamber that has a lower end corresponding in position to the teeth of the positioning rail, a guide rail arranged inside the accommodation chamber, a positioning plug received in the accommodation chamber and movably fit over the guide rail, whereby the positioning plug is selectively and downward movable to have a lower end of the positioning plug projecting through the lower end of the accommodation chamber and engaging the teeth of the positioning rail for positioning and fixing the roll retainer.

2. The label roll positioning device as claimed in claim 1, wherein when the top portion of each roll retainer has an inside surface opposing each other and forming a rotation axle.

3. The label roll positioning device as claimed in claim 1, wherein the bottom of the roll retainer forms a mounting portion that is slidably fit and mounted to the positioning rail.

4. The label roll positioning device as claimed in claim 1, wherein the lower end of the accommodation chamber forms a projection notch through which the locking section of the positioning plug selectively projects outward.

5. The label roll positioning device as claimed in claim 1 further comprising a face panel closing the accommodation chamber.

6. The label roll positioning device e as claimed in claim 5, wherein the face panel forms an operation opening through which an operation handle of the positioning plug extends outward.

7. The label roll positioning device as claimed in claim 1, wherein the positioning plug comprises an operation handle formed at one side thereof.

8. The label roll positioning device as claimed in claim 1, wherein the lower end of the positioning plug forms a locking section.
